(19) United States
(12) Patent Application Publication
(10) Pub. No.: US 2004/0153850 A1
(43) Pub. Date: Aug. 5, 2004

(54) Apparatus and method for automated electrical validation to detect and analyze worst case SSO condition

(76) Inventors: Zale T. Schoenborn, Portland, OR (US); Stuart B. Orford, Brush Prairie, WA (US); Jefferson Jones, Beaverton, OR (US); Jeff W. Fearing, Olympia, WA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/324,843

(22) Filed: Dec. 20, 2002

(51) Int. Cl. H04B 1/74

(52) U.S. Cl. 714/43

(57) ABSTRACT

A method and apparatus for automated electrical validation to detect and analyze worst case SSO conditions are described. In one embodiment, the method includes driving a plurality of switching I/O patterns having a predetermined frequency content to achieve a plurality of varying stress levels within an I/O subsystem selected for electrical validation. When a problematic I/O pattern is detected, the problematic I/O pattern is driven through the I/O subsystem in order to identify problematic behavior within the I/O subsystem. Once the problematic behavior is resolved, the method may be repeated while margining an input reference voltage or system platform timing until electrical validation of the selected I/O subsystem is complete.

### FIELD OF THE INVENTION

One or more embodiments of the invention relate generally to the field of electrical validation. More particularly, one embodiment of the invention relates to a method and apparatus for automated electrical validation to detect and analyze worst case simultaneous switching output (SSO) condition.

### BACKGROUND OF THE INVENTION

Microprocessor manufacturers are engaged in a constant race to produce the fastest microprocessor based platform. The burden to outdo the competition, by generating the fastest microprocessor to date, bounces back and forth between the various microprocessor manufacturers as microprocessors with increasing clockspeeds come to market. This fierce composition is further exacerbated by the continuous demand for even faster processors that effectively perform entertainment-based, media applications, as well as other computationally intensive applications. As a result, the time available to a microprocessor manufacturer to market a new microprocessor-based platform is steadily decreasing.

However, the continuously expanding platform speeds lead to the growing complexity of the microprocessor-based platforms. Consequently, microprocessor manufacturers are presented with a limited amount of time for performing electrical validation of their microprocessor-based platform designs. As known to those skilled in the art, electrical validation refers to the analysis of a microprocessor-based platform to verify that the platform's performance falls within predetermined, acceptable error margins. In essence, the goal of electrical validation is to detect system failures prior to marketing of a desired product.

Unfortunately, the sources of error within microprocessor systems are quite numerous. One such source of errors within microprocessor-based systems is system noise. As known to those skilled in the art, noise is a deviation of a signal from its intended or ideal value. In effect, the intended signal may be corrupted by a number of noise sources, resulting in a additive noise detected in a received signal. Consequently, to transmit information reliably, noise must be managed by having a large signal-to-noise ratio or by predicting or measuring the noise and rejecting the noise in received signals.

In effect, the additive noise or corruption of received signals may come from various sources, including but not limited to, power supply noise, transmitter and receiver offset parameter mismatch, cross-talk noise inflicted by parallel signals, intersymbol interference, timing noise and the like. Together, these error sources can lead to the propagation of noise to quiet drivers, leading to the detection of false switching at remote receivers, which is referred to herein as simultaneous switching output (SSO).

Various techniques have been devised to reduce system noise in order to limit SSO conditions within accepted error margins. Generally, methods for performing platform validation begin by identifying a pathological worst case error condition. In the area of platform validation, a worst case input/output (I/O) switching event can dominate validation and designed resources, as well as time. Unfortunately, detecting a worst case I/O switching event can be a very time-consuming process. Consequently, detecting an unexpected worst case I/O switching event late in the validation schedule can seriously jeopardize a product launch schedule. Therefore, there remains a need to overcome one or more of the limitations in the above-described, existing art.

### BRIEF DESCRIPTION OF THE DRAWINGS

The various embodiments of the present invention are illustrated by way of example, and not by way of limitation, in the figures of the accompanying drawings and in which:

FIG. 1 depicts a block diagram illustrating a computer system in which electrical validation, in accordance with one embodiment of the present invention, may be practiced.

FIG. 2 depicts a block diagram illustrating a plurality of input/output (I/O) patterns, in accordance with one embodiment of the present invention.

FIG. 3 depicts a scope debug mode display screen, in accordance with a further embodiment of the present invention.

FIG. 4 depicts a failing data screen, in accordance with a further embodiment of the present invention.

FIG. 5 depicts a voltage reference (Vref) margining card, in accordance with a further embodiment of the present invention.

FIG. 6 depicts a flowchart illustrating a method for automated electrical validation to detect and analyze worse case simultaneous switching output (SSO) conditions, in accordance with a further embodiment of the present invention.

FIG. 7 depicts a flowchart illustrating an additional method for driving a plurality of I/O patterns within a selected I/O subsystem to achieve a plurality of varying system stress levels, in accordance with a further embodiment of the present invention.

FIG. 8 depicts a flowchart illustrating an additional method for generating a plurality of I/O patterns having a predetermined switching rate content, in accordance with the further embodiment of the present invention.

FIG. 9 depicts a flowchart illustrating an additional method for generating a plurality of I/O patterns, in accordance with the further embodiment of the present invention.

FIG. 10 depicts a flowchart illustrating an additional method for detecting problematic I/O patterns driven through a selected I/O subsystem, in accordance with the further embodiment of the present invention.

FIG. 11 depicts a flowchart illustrating an additional method for generating a failing data screen, in accordance with the further embodiment of the present invention.

FIG. 12 depicts a flowchart illustrating an additional method for driving an uncorrupted version of a corrupted I/O pattern, in accordance with the further embodiment of the present invention.

FIG. 13 depicts a flowchart illustrating an additional method for margining an input reference voltage during electrical validation, in accordance with a further embodiment of the present invention.

FIG. 14 depicts a flowchart illustrating a method for driving a plurality of I/O patterns having a predetermined frequency content to achieve a plurality of stress levels within an I/O system selected for electrical validation in order to detect problematic behavior within the selected I/O subsystem, in accordance with one embodiment of the present invention.

FIG. 15 depicts a flowchart illustrating an additional method for generating the plurality of I/O patterns having the predetermined frequency content, in accordance with the further embodiment of the present invention.

FIG. 16 depicts a flowchart illustrating an additional method for generating the plurality of I/O patterns according to minimum and maximum switching frequencies of the selected I/O subsystem, in accordance with the further embodiment of the present invention.

FIG. 17 depicts a flowchart illustrating an additional method for combining selected I/O patterns in order to generate a plurality of frequency modulated I/O patterns, in accordance with the further embodiment of the present invention.

FIG. 18 depicts a flowchart illustrating an additional method for generating a plurality of I/O patterns, in accordance with a plurality of predetermined victim bit modes, in accordance with the further embodiment of the present invention.

FIG. 19 depicts a flowchart illustrating an additional method for driving the I/O patterns by sweeping a switching rate of the I/O patterns, in accordance with a further embodiment of the present invention.

FIG. 20 depicts a flowchart illustrating an additional method for driving the I/O patterns by sweeping a duty cycle of the I/O patterns, in accordance with a further embodiment of the present invention.

### DETAILED DESCRIPTION

A method and apparatus for automated electrical validation to detect and analyze worst case SSO conditions are described. In one embodiment, the method includes driving a plurality of switching I/O patterns having a predetermined frequency content to achieve a plurality of varying stress levels within an I/O subsystem selected for electrical validation. When a problematic I/O pattern is detected, the problematic I/O pattern is driven through the I/O subsystem in order to identify problematic behavior within the I/O subsystem. Once the problematic behavior is resolved, the method may be repeated while margining an input reference voltage or system platform timing until electrical validation of the selected I/O subsystem is complete.

In the following description, for the purposes of explanation, numerous specific details are set forth in order to provide a thorough understanding of the embodiments of the present invention. It will be apparent, however, to one skilled in the art that the various embodiments of the present invention may be practiced without some of these specific details. In addition, the following description provides examples, and the accompanying drawings show various examples for the purposes of illustration. However, these examples should not be construed in a limiting sense as they are merely intended to provide examples of the embodiments of the present invention rather than to provide an exhaustive list of all possible implementations of the embodiments of the present invention. In other instances, well-known structures and devices are shown in block diagram form in order to avoid obscuring the details of the various embodiments of the present invention.

Portions of the following detailed description may be presented in terms of algorithms and symbolic representations of operations on data bits. These algorithmic descriptions and representations are used by those skilled in the data processing arts to convey the substance of their work to others skilled in the art. An algorithm, as described herein, refers to a self-consistent sequence of acts leading to a desired result. The acts are those requiring physical manipulations of physical quantities. These quantities may take the form of electrical or magnetic signals capable of being stored, transferred, combined, compared, and otherwise manipulated. Moreover, principally for reasons of common usage, these signals are referred to as bits, values, elements, symbols, characters, terms, numbers, or the like.

However, these and similar terms are to be associated with the appropriate physical quantities and are merely convenient labels applied to these quantities. Unless specifically stated otherwise, it is appreciated that discussions utilizing terms such as “processing” or “computing” or “calculating” or “determining” or displaying” or the like, refer to the action and processes of a computer system, or similar electronic computing device, that manipulates and transforms data represented as physical (electronic) quantities within the computer system's devices into other data similarly represented as physical quantities within the computer system devices such as memories, registers or other such information storage, transmission, display devices, or the like.

The algorithms and displays presented herein are not inherently related to any particular computer or other apparatus. Various general purpose systems may be used with programs in accordance with the teachings herein, or it may prove convenient to construct more specialized apparatus to perform the required method. For example, any of the methods according to the various embodiments of the present invention can be implemented in hard-wired circuitry, by programming a general-purpose processor, or by any combination of hardware and software.

One of skill in the art will immediately appreciate that the invention can be practiced with computer system configurations other than those described below, including hand-held devices, multiprocessor systems, microprocessor-based or programmable consumer electronics, digital signal processing (DSP) devices, network PCs, minicomputers, mainframe computers, and the like. The embodiments of the invention can also be practiced in distributed computing environments where tasks are performed by remote processing devices that are linked through a communications network. The required structure for a variety of these systems will appear from the description below.

It is to be understood that various terms and techniques are used by those knowledgeable in the art to describe communications, protocols, applications, implementations, mechanisms, etc. One such technique is the description of an implementation of a technique in terms of an algorithm or mathematical expression. That is, while the technique may be, for example, implemented as executing code on a computer, the expression of that technique may be more aptly and succinctly conveyed and communicated as a formula, algorithm, or mathematical expression.

Thus, one skilled in the art would recognize a block denoting A+B=C as an additive function whose implementation in hardware and/or software would take two inputs (A and B) and produce a summation output (C). Thus, the use of formula, algorithm, or mathematical expression as descriptions is to be understood as having a physical embodiment in at least hardware and/or software (such as a computer system in which the techniques of the embodiments of the present invention may be practiced as well as implemented as an embodiment).

In an embodiment, the methods of the various embodiments of the present invention are embodied in machine-executable instructions. The instructions can be used to cause a general-purpose or special-purpose processor that is programmed with the instructions to perform the methods of the embodiments of the present invention. Alternatively, the methods of the embodiments of the present invention might be performed by specific hardware components that contain hardwired logic for performing the methods, or by any combination of programmed computer components and custom hardware components.

In one embodiment, the present invention may be provided as a computer program product which may include a machine or computer-readable medium having stored thereon instructions which may be used to program a computer (or other electronic devices) to perform a process according to one embodiment of the present invention. The computer-readable medium may include, but is not limited to, floppy diskettes, optical disks, Compact Disc, Read-Only Memory (CD-ROMs), and magneto-optical disks, Read-Only Memory (ROMs), Random Access Memory (RAMs), Erasable Programmable Read-Only Memory (EPROMs), Electrically Erasable Programmable Read-Only Memory (EEPROMs), magnetic or optical cards, flash memory, or the like.

Accordingly, the computer-readable medium includes any type of media/machine-readable medium suitable for storing electronic instructions. Moreover, one embodiment of the present invention may also be downloaded as a computer program product. As such, the program may be transferred from a remote computer (e.g., a server) to a requesting computer (e.g., a client). The transfer of the program may be by way of data signals embodied in a carrier wave or other propagation medium via a communication link (e.g., a modem, network connection or the like).

System Architecture

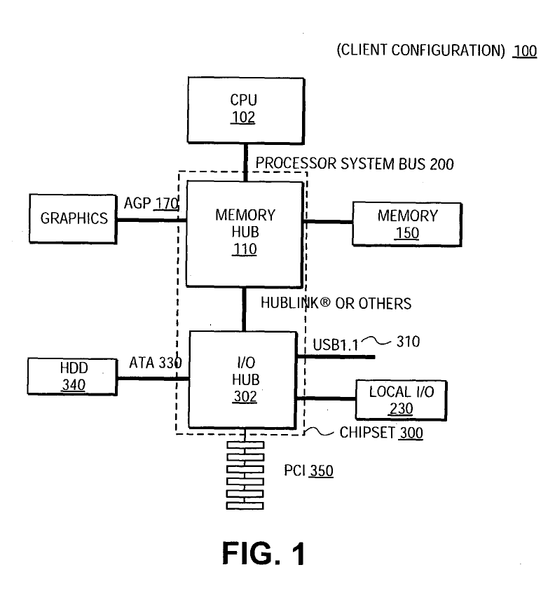

FIG. 1 depicts a block diagram illustrating a computer system 100 within which one embodiment of the present invention may be implemented. Computer system 100 comprises a processor system bus (front side bus) 200 for communicating information between a processor 102 and a memory hub 110, coupled together via the front side bus (FSB) 200. The computer system 100 also includes one or more temporary memory devices (memory) 150 coupled to memory hub 110 via memory bus 130. As described herein, memory 150 includes, but is not limited to, solid state memories, random access memories (RAM), synchronous RAM (SRAM), synchronous data RAM (SDRAM) or any device capable of supporting high speed buffering of data. In addition, the computer system may include one or more graphics devices 180 coupled to memory hub 110 via accelerated graphics port (AGP) 170.

Likewise, the computer system includes an I/O subsystem comprised of I/O hub 300. As illustrated, the I/O hub 300 may be coupled via an I/O bus 360 to memory hub 110. As illustrated, I/O hub 300 may be coupled to a universal serial bus (USB) 310, local I/O 330, as well as peripheral component interconnect devices (PCI) 350. Finally, the I/O hub 300 is also coupled to hard disk drive devices (HDD) via an advanced technology attachment (ATA) bus 330.

As depicted in FIG. 1, the computer system 100 is illustrated in a client configuration. As illustrated, the PC platform computer system 100 supports a variety of application-specific buses alongside the PCI expansion bus, as illustrated in FIG. 1. Generally, the memory hub 110 and I/O hub 100 may form a system chipset, which communicates with the CPU 102. Within computer systems, for example as depicted in FIG. 1, the processor system bus, or front side bus, 200 continues to scale in both frequency and voltage at a rate that will continue for the foreseeable future. Likewise, memory bandwidths have increased to keep pace with the processor, such as central processor (CPU) 102. As illustrated in FIG. 1, the chipset may be partitioned as a memory hub and I/O hub, since the memory bus 130 often changes with each processor generation. However, one of the major functions of the chipset is to isolate the ever-changing buses from the stable I/O bus.

As described above, the continuously expanding platform speeds lead to growing complexity of microprocessor-based platforms, for example as depicted in FIG. 1. Consequently, the microprocessor manufacturers are presented with a limited amount of time for performing electrical validation of their processor-based platform designs. However, the constant race between microprocessor manufacturers to be the first to bring the fastest microprocessor-based platform to market reduces the amount of time provided to manufacturers to perform electrical validation and detect system failures prior to marketing of a desired product.

Moreover, the sources of error within microprocessor systems are quite numerous. Sources of error, such as system noise, can result in additive noise detected in a received signal. Consequently, to transmit information reliably and in order to best be managed by having a large signal-to-noise ratio are predicted or measuring the noise and rejecting the noise in received signals. In effect, the additive noise or corruption of received signals may come from various sources, including but not limited to power supply noise, transmitter and receiver offset parameter mismatch, cross-talk, noise inflicted by parallel signals, intersymbol interference, timing noise and the like. Together, these errors can lead to the propagation of noise to quiet drivers, leading to the detection of false switching at remote receivers or simultaneous switching output (SSO).

Generally, methods for performing validation of a platform begin by identifying a pathological worst case error condition. In the area of platform validation, a worst case input/output (I/O) switching event can dominate validation and designated resource, as well as time. Unfortunately, detecting a worst case I/O switching event can be a very time-consuming process. Consequently, detecting an unexpected worst case I/O switching event late in the validation cycle can seriously jeopardize a product launch schedule. Accordingly, one embodiment of the present invention provides a new methodology, which significantly decreases the amount of time to perform electrical validation of a system platform.

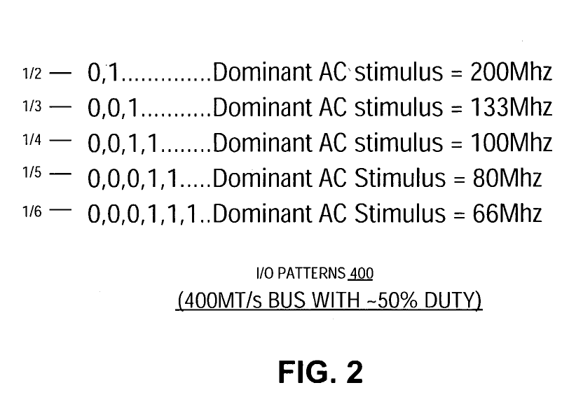

Referring now to FIG. 2, FIG. 2 depicts a block diagram illustrating a plurality of I/O patterns 400 in accordance with one embodiment of the present invention. As illustrated with reference to FIG. 2, a plurality of I/O patterns 400 are generated for, for example, a selected I/O bus having a 400 megatransfer (MT) per second (/s) switching rate (frequency) with a fifty percent duty cycle. However, the I/O patterns presented in FIG. 2 are illustrated to provide one possible subset of I/O patterns and therefore should not be construed in a limiting sense.

As illustrated, the various I/O patterns can generate a plurality of varying switching rates within an I/O subsystem selected for electrical validation. As illustrated, the various I/O patterns cause switch frequencies (rates) from 200 megahertz (MHz) through 66 MHz for a 50% duty cycle within the selected I/O subsystem. As known to those skilled in the art, a duty cycle refers to the ratio of rising and falling signal transitions. Accordingly, embodiments of I/O patterns may include duty cycles ranging from, for example, 10% through 90% duty cycles. However, as will be recognized by those skilled in the art, generating a system stress level is maximized by utilizing a 50% duty cycle.

Consequently, as illustrated with reference to FIG. 2, the highest switching frequency within, for example, FSB 200 as depicted in FIG. 1, that is simulated in accordance with embodiments of the present invention, is when the bus toggles with a data pattern of 0,1,0,1,0 at 200 MHz based on five nanosecond period. Likewise, a 50 MHz rate is achieved by the pattern 1,1,1,1,0,0,0,0, while a 100 MHz rate is achieved with a pattern of 1,1,0,0,1,1,0,0. The total list of discreet I/O frequency stimulus implemented for, for example, FSB 200, may include the following: 200, 133, 100, 80, 66, 47, 50, 44, 40, 36, 33, 30, 29, 27, and 25 MHz.

Accordingly, as described in further detail below, the various I/O patterns depicted in FIG. 2 may be generated and driven through I/O subsystems selected from, for example, computer system 100, to analyze various I/O components within the system. For example, the CPU may perform various reads and writes of the data patterns, or I/O patterns, to memory 150 and read back the various data patterns to determine whether the data pattern was corrupted. In one embodiment, this is performed during a loop mode, wherein the electrical validation embodiment of the present invention loops through each of a plurality of I/O patterns until a problematic I/O pattern is detected. In one embodiment, problematic I/O patterns may include those corrupted by the system 100. Otherwise, the loop mode continues until a user aborts the electrical validation test.

Consequently, switching I/O patterns having a predetermined frequency content enable varying the duty cycles and switching frequencies simulated by the various I/O patterns. As a result, a device can be pushed to its limit in order to verify set-up and hold times, as well as avoiding of various sources of error. To that end, one embodiment of the present invention designates a bit within each I/O pattern as a victim bit and the remaining bits within the I/O pattern as aggressor bits. In doing so, electrical validation of a system component is improved by expanding the various possible I/O patterns, which may be run through a system to incur problematic behavior, such as a system to failure.

TABLE 1

| | |
|---|---|
| Single bit switching | Victim switches by itself (used as baseline in |
| | debug |
| Even mode | Victim and aggressors switch together |
| Odd mode | Victim and aggressors switch in opposite |
| | direction |
| Max Frequency | Victim switches at the maximum I/O rate |
| | regardless of the aggressors switching period |
| Victim High | Victim stays high |
| Victim Low | Victim stays low |

### Electrical Validation Victim Modes

Accordingly, in one embodiment, generation of the various I/O patterns runs according to, for example, six modes. The modes create the scenario where a victim line switches in various relationships to as many aggressor lines as possible. The six modes are listed above, with reference to Table 1. As indicated in Table 1, a first mode includes a single bit switching mode, wherein the victim switches by itself. In one embodiment, single bit switching mode is used as a baseline for debugging and electrical validation of the system. A second mode is termed “even mode”, wherein the victims and aggressors switch together.

As depicted with reference to FIG. 2, FIG. 2 lists a possible implementation of the even mode. A further mode is provided, which is termed “odd mode”, wherein the victims and aggressors switch in opposite directions. For example, as depicted with reference to FIG. 2, the aggressor bit would switch according to the designated switching frequency, while the designated victim bit would switch in an opposite direction. For example, when the aggressor lines are high, the victim bit is low, while when the aggressor lines are low, the victim bit is high.

A maximum frequency mode is also provided, wherein the victim switches at the maximum switch rate regardless of the behavior of the aggressor lines. A victim high mode is also provided, wherein the victim stays high regardless of the behavior of the aggressor lines. Finally, a victim low mode is provided wherein the victim stays low, regardless of the behavior of the aggressor lines. As such, utilizing the various aggressor modes, I/O patterns are generated such that each bit within the various possible plurality of I/O patterns is selected as a victim bit until each bit within the I/O patterns has functioned as the victim bit.

In addition, for each bit within the I/O pattern that is selected as the victim bit, patterns are generated for each of the possible victim modes, provided in Table 1, in order to generate a plurality of I/O patterns, a subset of which are provided in FIG. 2 in order to avoid obscuring details regarding embodiments of the present invention. Moreover, the I/O patterns are described with reference to a 400 MTS/s front side bus. However, various stress patterns will be generated for each of the I/O components of computer system 100, as depicted in FIG. 1, and therefore possible devices under test (DUTs) for electrical validation are not limited to front side bus devices. Accordingly, in one embodiment, the term “predetermined frequency content” may include, but is not limited to, varying duty cycles, switching rates, victim bit modes, frequency modulation and the like, simulated by the switching I/O patterns when driven within a DUT.

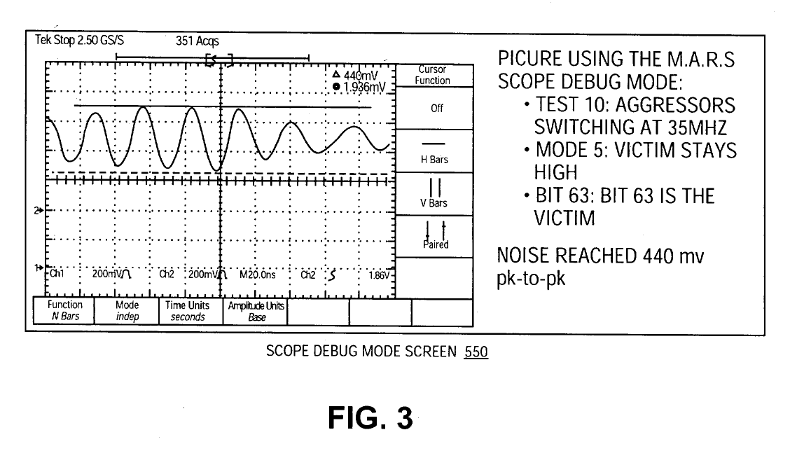

Referring now to FIG. 3, FIG. 3 depicts a scope mode debug screen 550, in accordance with a further embodiment of the present invention. In one embodiment, the scope debug mode screen 550 is generated following detection of a problematic I/O pattern, such as a corrupted data pattern detected during the loop mode. As illustrated, the scope debug mode screen 500 allows a user to drive a problematic I/O pattern in order to detect a source problematic behavior leading to the corruption of the data pattern. Consequently, by driving the problematic I/O pattern, a user can detect a source of any corruption of the I/O pattern, as well as a source of the problematic behavior, such as a system failure. In doing so, electrical validation can be performed in order to detect problematic behavior, such as various system errors prior to product release.

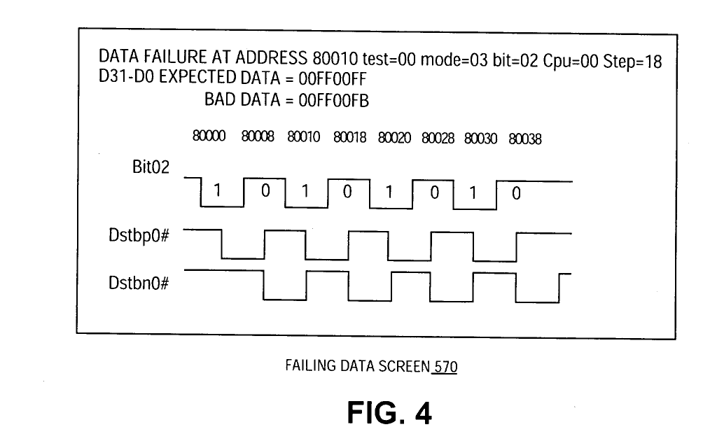

Referring now to FIG. 4, FIG. 4 depicts a failing data screen 570, which may be generated following the detection of a problematic I/O pattern, such as a data corruption detected during a loop mode. Generally, when problematic behavior, such as an error, is detected during the loop mode, the electrical validation, in accordance with one embodiment of the present invention, will generate the failing data screen 570. In one embodiment, the failing data screen includes a switching frequency (rate) of the problematic I/O pattern, a value indicating which bit within the data pattern is problematic, a test mode, an expected I/O pattern, the corrupted I/O pattern, an address of the data failure, along with a reference voltage (Vref) level.

As described in further detail below, further electrical validation may be provided by margining the input reference voltage and system timing of the DUT for electrical validation. Generally, the information provided on the failing data screen 570 is illustrated to a user. Based on the failing data screen 570, the user may desire to enter a scope mode and is presented with a scope mode debug screen 550, for example as depicted in FIG. 3. In one embodiment, the scope mode debug screen 550 allows the user to drive an uncorrupted version of a corrupted I/O pattern in isolation to detect and resolve a source of the problematic system behavior causing the corruption.

As referred to above, a further embodiment of the present invention provides for margining of a reference voltage of the DUT while repeating the loop modes and scope modes. As known to those skilled in the art, voltage reference (Vref) is the gunning transistor logic (GTL) reference voltage, which the agents on, for example, a host bus, use to determine the voltage level at their input receiver pins. In one embodiment, the goal of margining Vref is to detect problematic behavior, such as signal integrity issues that lead to reduced noise or timing margin in an I/O subsystem selected for electrical validation.

Generally, the Vref is typically derived from a resistive voltage divider network located near each agent. Accordingly, previous methods of finding Vref margin remove and replace a divider network with an external power supply to provide the reference voltage (Vref) and margin the Vref while random operating system applications run until a failure is detected. Unfortunately, these conventional methods induce a system failure without any indication of what signals on the host device may have contributed to the failure.

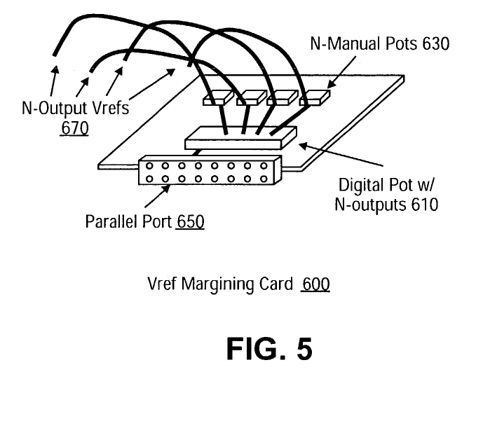

Accordingly, as depicted with reference to FIG. 5, one embodiment of the present invention describes a Vref margining card 600 in accordance with one embodiment of the present invention. In one embodiment, the Vref margining card 600 may include digital POTs with N-outputs 610, N-manual POT 630, N-output Vref 670, as well as parallel port 650. As such, in one embodiment, the Vref outputs from the potentiometer are connected to the individual processor Vref inputs in place of a processor Vref divided circuit. Once connected, margin card 600 enables margining of the Vref voltage according to a voltage margin of the DUT.

Accordingly, utilizing the Vref margining card 600, the reference voltage may be margined on, for example, the processor as well as the DUT, for electrical validation, while performing the loop mode and corresponding scope mode. In one embodiment, the Vref margining card 600 is comprised of a printed circuit board (PCB) which houses, for example, an XICOR® X9241 Quad E²POT™ Nonvolatile Digital Potentiometer. The X9241 integrates four nonvolatile E²POT digitally controlled potentiometers on a monolithic microcircuit. In one embodiment, the X9241 contains four register arrays, each comprised of 63 resistive elements. As such, the Vref margining card 600 enables electrical validation to determine whether a DUT complies with an indicated reference voltage margin.

Accordingly, as described in the above embodiments, the electrical validation program described generates data patterns that provide worst case noise on a DUT, such as for example, a host bus. By generating I/O patterns over various switching frequencies, the frequency which is excited is varied over a wide range of possible multiples of the minimum and maximum I/O switching rate (frequency/period). Likewise, the electrical validation program controls programmable potentiometers within the Vref margining card 600 that replaced the platform Vref generation circuits in order to push the system to failure. Use of the electrical validation program can reduce the time to determine a platform's margin from days, weeks or months to minutes. Procedural methods for implementing the embodiments of the present invention are now described.

Operation

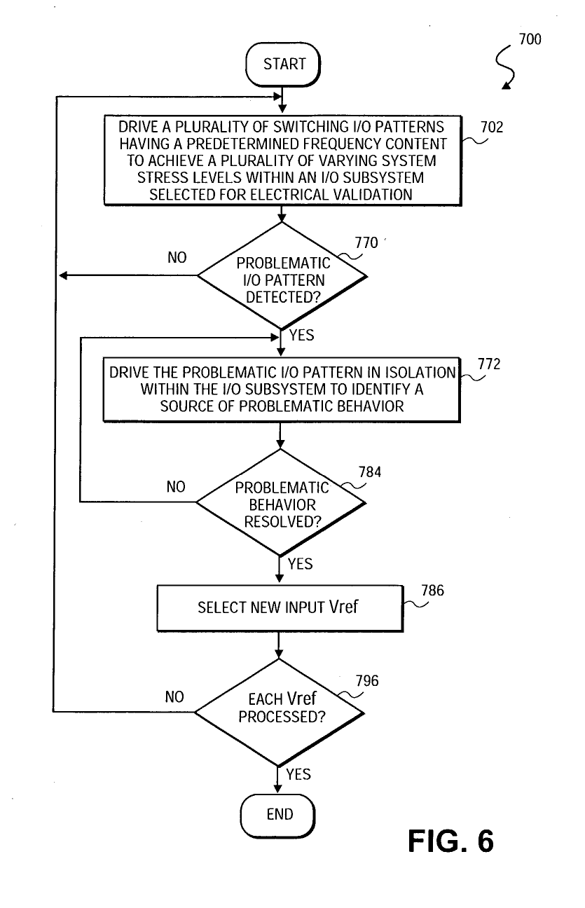

Referring now to FIG. 6, FIG. 6 depicts a flowchart illustrating a method 700 for automated electrical validation to detect and analyze worst case SSO conditions within, for example, I/O components of computer system 100, as depicted in FIG. 1, in accordance with one embodiment of the present invention. At process block 702, a plurality of switching I/O patterns having a predetermined frequency content are driven to achieve a plurality of varying system stress levels within an I/O subsystem selected for electrical validation. At process block 770, it is determined whether a problematic I/O pattern is detected. When a problematic I/O pattern is detected, at process block 772, the problematic I/O pattern is driven in isolation within the system to identify a source of problematic system behavior.

In one embodiment, a problematic I/O pattern may include an I/O pattern corrupted by the selected I/O subsystem while driven through the selected I/O subsystem. In one embodiment, the corruption is indicative of problematic system behavior, including, but not limited to, system integrity issues that lead to reduced noise or timing margins, failure to meet acceptable error margins due to system noise, including, but not limited to, power supply noise, transmitter and receiver offset parameter mismatch, cross-talk noise, inter-symbol interference, timing noise and the like.

Consequently, problematic system behavior can result in false detection of switching at remote receivers or simultaneous switching output (SSO). Accordingly, at process block 784, it is determined whether the problematic system is resolved. Once problematic system behavior is resolved, at process block 786, an input reference voltage is selected and provided to the selected I/O subsystem. Finally, at process block 796, process blocks 702-786 are repeated for each input reference voltage (Vref) within a predetermined Vref voltage range of the selected I/O subsystem.

As described above, process block 702 refers to a “loop mode” wherein the method loops through a plurality of generated I/O patterns. Likewise, process block 772 refers to a “scope mode”, which allows a system user to drive the problematic I/O data pattern in isolation to detect and resolve problematic system behavior. Finally, process blocks 786 and 796 refer to a “Vref margining mode”, wherein the loop modes and scope modes are repeated while varying the input reference voltage provided to a device under test, or DUT, in order to drive the system to incur problematic behavior, such as failure. Utilizing the various modes, a device under test can be validated within a drastically reduced amount of time in order to provide a platform to the market while ensuring compliance with electrical validation parameters.

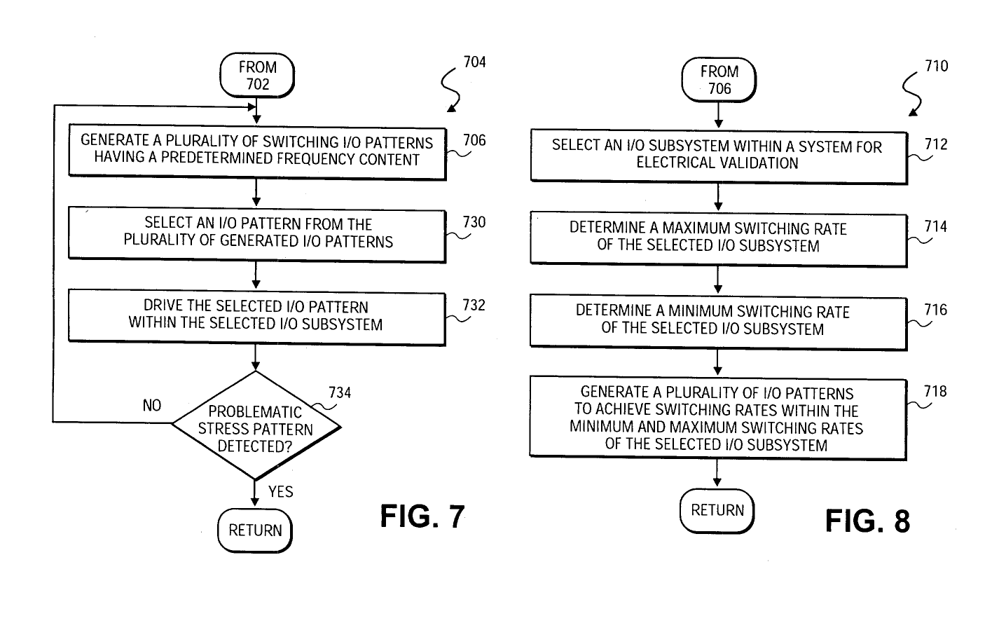

Referring now to FIG. 7, FIG. 7 depicts a flowchart illustrating an additional method 704 for driving the plurality of I/O patterns within the I/O subsystem of process block 702, as depicted in FIG. 6. At process block 706, a plurality of switching I/O patterns are generated having a predetermined frequency content. In one embodiment, this is perfomed, for example, as depicted in FIG. 2. As illustrated in FIG. 2, I/O patterns are generated according to various duty cycles to simulate a maximum switching rate of a selected DUT, as well as a plurality of variations thereof, down to a minimum switching rate of the DUT. Once generated, at process block 730, an I/O pattern is selected from the plurality of generated I/O patterns.

Once an I/O pattern is selected, at process block 732, the selected I/O pattern is driven within the I/O subsystem. Finally, at process block 734, process blocks 706-732 are repeated until a problematic I/O pattern is detected. In one embodiment, a problematic I/O pattern refers to an I/O pattern corrupted during driving of the problematic I/O pattern through the I/O subsystem. In one embodiment, electrical validation is performed on front side bus 200 by performing memory reads and writes from CPU 102 through memory 150. However, various other DUTs may be selected for performing electrical validation testing, including but not limited to AGP port 170, memory bus 130, chipset bus 180, as well as ATA bus 330 and USB bus 310.

Referring now to FIG. 8, FIG. 8 depicts a flowchart illustrating an additional method 710 for generating the plurality of I/O patterns at process block 706. At process block 712, an I/O subsystem within the system is selected for electrical validation (DUT). Once selected, at process block 714, a maximum switching rate of the selected DUT is determined. Next, at process block 716, a minimum switching rate of the selected DUT is determined. Finally, at process block 718, a plurality of I/O patterns are generated to achieve switching rates within the minimum and maximum switching rate of the selected DUT, for example, as illustrated with reference to FIG. 2.

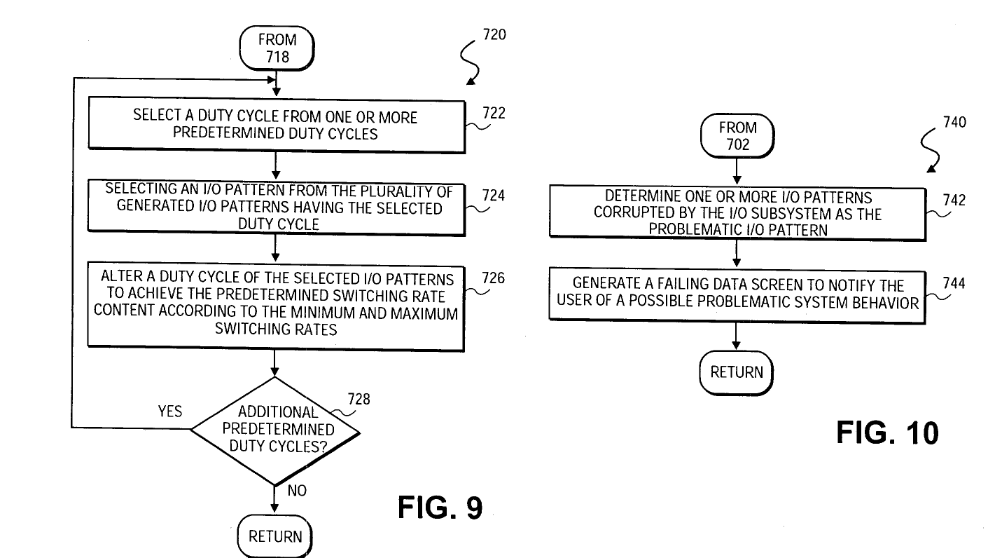

Referring now to FIG. 9, FIG. 9 depicts a flowchart illustrating an additional method 720 for generating the plurality of I/O patterns of process block 718, as depicted in FIG. 8. At process block 722, a duty cycle is selected from one or more predetermined duty cycles. Once selected, at process block 724, one or more I/O patterns are selected having a duty cycle matching the selected duty cycle. Next, at process block 726, a plurality of I/O patterns are generated by altering a duty cycle of the selected I/O pattern to achieve the frequency content according to the minimum and maximum switching rates. Finally, at process block 728, process blocks 722-726 are repeated for each predetermined duty cycle.

Referring now to FIG. 10, FIG. 10 depicts a flowchart illustrating an additional method 740 for driving the plurality of I/O patterns within the I/O subsystem of process block, as depicted in FIG. 6, in accordance with a further embodiment of the present invention. At process block 742, one or more I/O patterns corrupted by the I/O subsystem during driving of the plurality of I/O patterns are determined as the problematic I/O pattern(s). Once the one or more corrupted I/O patterns are determined, at process block 744, a failing data screen is generated to notify the user of problematic possible system behavior. In one embodiment, the generated failing data screen is provided, for example, as illustrated with reference to FIG. 4.

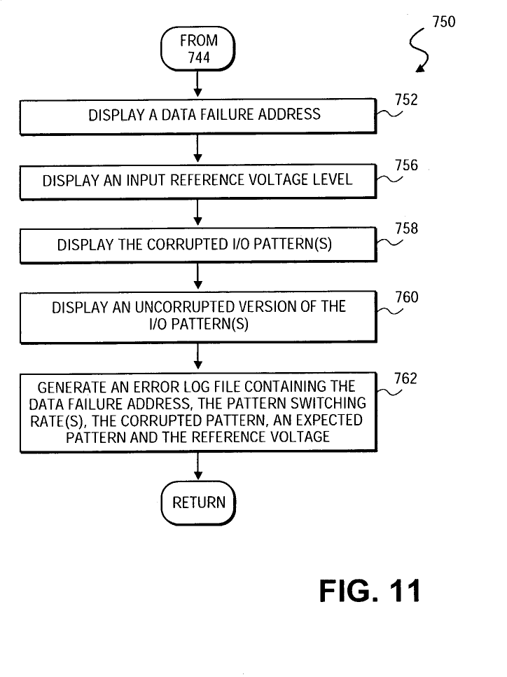

Referring now to FIG. 11, FIG. 11 depicts a flowchart illustrating an additional method 750 for generating the failing data screen of process block 744, in accordance with the further embodiment of the present invention. At process block 752, a data failure address is displayed for each detected problematic (corrupted) I/O pattern. Likewise, at process block 756, an input reference voltage level of the selected I/O subsystem is displayed. At process block 758, each corrupted I/O pattern is displayed. Likewise, at process block 760, an uncorrupted version of each I/O pattern is displayed.

In accordance with the further embodiment, at process block 762, an error log file is generated containing each data failure address, each pattern switching rate, each corrupted pattern, each unexpected pattern, the reference voltage level and a failing data bit and a debug mode. In one embodiment, the error log file is generated in the event that the problematic system behavior crashes the entire system, including the process running the electrical validation as described within the embodiments of the present invention.

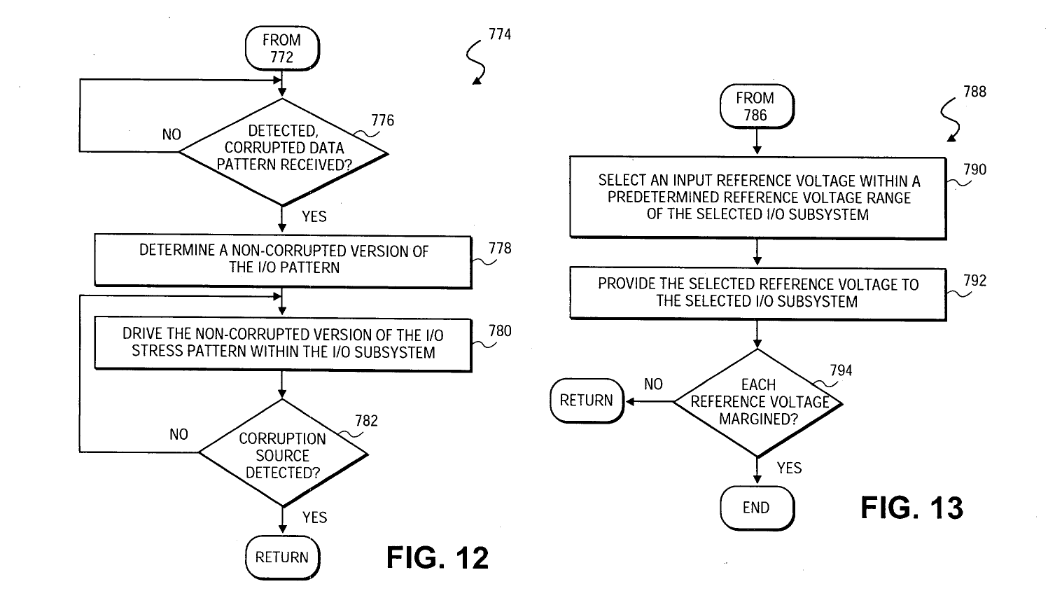

Referring now to FIG. 12, FIG. 12 depicts a flowchart illustrating an additional method 774 for driving the non-corrupted version of the corrupted I/O pattern of process block 772, as depicted in FIG. 6, in accordance with a further embodiment of the present invention. At process block 776, it is determined whether a corrupted data pattern of the problematic I/O pattern is received. Once received, at process block 778, a non-corrupted version of the received I/O patterns is determined. Once determined, at process block 780, the non-corrupted version of the I/O pattern is driven within the I/O subsystem. Finally, at process block 782, process blocks 778 and 780 are repeated until a source of the corrupted I/O pattern is detected. As described above, the process 774 refers to the scope mode, which enables a user to drive a non-corrupted version of an I/O pattern in isolation in order to detect a source of the problematic system behavior.

Finally, referring to FIG. 13, FIG. 13 depicts a flowchart illustrating an additional method 708 for providing a selected input reference voltage of process block 786, as depicted in FIG. 6, in accordance with the further embodiment of the present invention. At process block 790, a reference voltage within a predetermined reference voltage range of the I/O subsystem selected for electrical validation is selected. Once selected, at process block 792, the selected input reference voltage is provided to the selected I/O subsystem. Finally, at process block 794, process blocks 790-792 are repeated for each input reference voltage within the predetermined reference voltage range.

Accordingly, as illustrated with reference to FIG. 6, process block 796 requires repeating of the loop modes and scope modes for each reference voltage within a predetermined reference voltage range. In general, the reference voltage will include positive and negative reference voltage increments, which are cycled through, while repeating of the loops modes and scope modes in order to push the I/O subsystem to perform problematic behavior, such as failure, and verify that the I/O subsystem contains sufficient error margins to comply with the indicated margin reference voltage range.

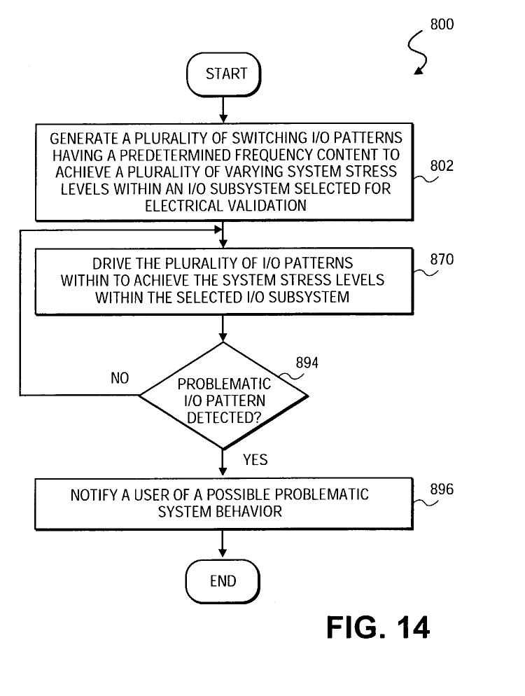

Referring now to FIG. 14, FIG. 14 depicts a flowchart illustrating a method 800 for performing electrical validation according to a loop mode within a device under test (DUT), for example, an I/O subsystem of computer system 100, as depicted in FIG. 1, in accordance with one embodiment of the present invention. In this embodiment, the various victim bit modes provided in Table 1 are utilized to expand the subset of I/O patterns provided in FIG. 2. As described below, each bit within the I/O patterns provided in FIG. 2 is utilized as a victim bit and set according to the victim bit mode provided in, for example, Table 1.

As such, the amount of available I/O patterns can be greatly expanded beyond the subset provided in FIG. 2 in order to thoroughly test a system component, such as the DUT, through a plurality of system stress levels in order to perform electrical validation of the DUT. Accordingly, in one embodiment, the plurality of available I/O patterns provide a frequency content to thoroughly test the entire spectrum of switching rates (frequencies/periods) supported by a DUT in order to verify proper operation of the DUT.

Referring again to FIG. 14, at process block 802, a plurality of switching I/O patterns are generated to achieve a predetermined frequency content. Once generated, at process block 870, the plurality of I/O patterns are driven within an I/O subsystem selected from a system to perform electrical validation thereof by causing a plurality of varying system stress levels within the I/O subsystem. Next, at process block 872, it is determined whether a problematic I/O pattern is detected. When a problematic I/O pattern is detected, a user is notified of the possible problematic system behavior, for example, as depicted in FIG. 4. Otherwise, process block 870 is repeated until either a problematic I/O pattern is detected or the loop mode is terminated by, for example, a user.

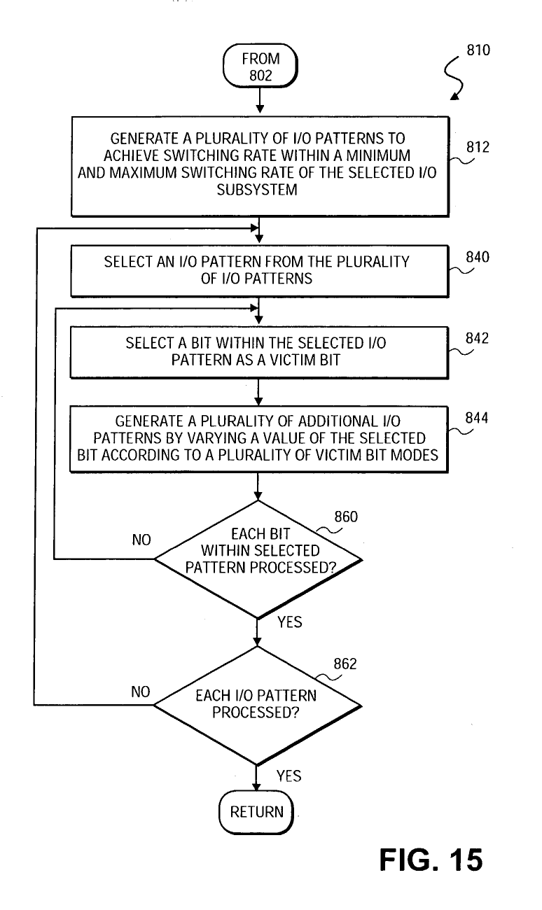

Referring now to FIG. 15, FIG. 15 depicts a flowchart illustrating an additional method 810 for generating the plurality of I/O patterns of process block 802, as depicted in FIG. 14, in accordance with a further embodiment of the present invention. At process block 812, a plurality of I/O patterns are generated to achieve switching rates within a minimum and maximum switching rate of a device within the system selected for electrical validation (DUT). Once generated, at process block 840, an I/O pattern is selected from the plurality of I/O patterns. Once selected, a bit within the selected I/O pattern is selected as a victim bit.

As described above, in one embodiment, each bit position within each I/O pattern eventually is selected as a victim bit, thereby expanding the available I/O patterns beyond the I/O patterns 400, as depicted in FIG. 2. Accordingly, at process block 844, a plurality of additional I/O patterns are generated by varying a bit value of the victim bit according to a plurality of victim bit modes, for example, as depicted with reference to Table 1. At process block 860, process blocks 842 and 844 are repeated for each bit within the selected I/O pattern. Finally, at process block 862, process blocks 840-860 are repeated for each of the generated plurality of I/O patterns.

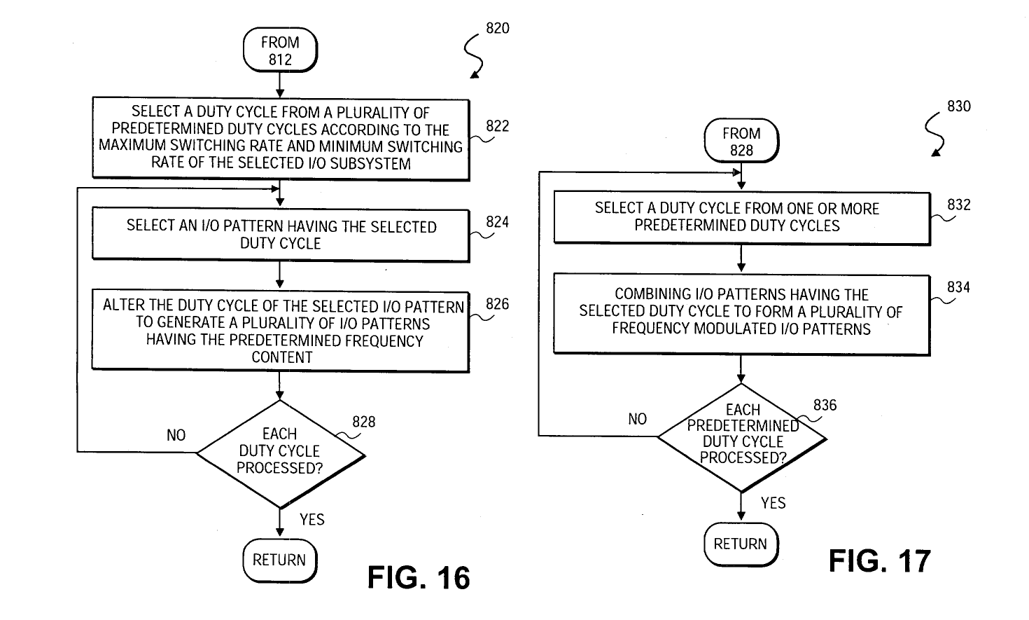

Referring now to FIG. 16, FIG. 16 depicts a flowchart illustrating an additional method 820 for generating the plurality of I/O patterns at process block 812, in accordance with the further embodiment of the present invention. At process block 822, a duty cycle is selected from a plurality of predetermined duty cycles according to the maximum switching rate and minimum switching rate of the selected device (DUT). Once selected, at process block 824, an I/O pattern having the duty cycle is selected from the plurality of I/O patterns. Once selected, at process block 826, a duty cycle of the selected I/O pattern is altered to generate a plurality of additional I/O patterns having the predetermined frequency content. Finally, at process block 828, process blocks 824 and 826 are repeated for each predetermined duty cycle. Accordingly, the various duty cycles within the DUT can be varied in order to perform electrical validation for the full spectrum of switching rate periods supported by the DUT.

Referring now to FIG. 17, FIG. 17 depicts a flowchart illustrating a method 830 for generating frequency modulated I/O patterns, in accordance with the further embodiment of the present invention. At process block 832, a duty cycle is selected from the one or more predetermined duty cycles. Once selected, at process block 834, I/O patterns having the selected duty cycle are combined to form a plurality of frequency modulated I/O patterns. Finally, at process block 836, process blocks 832 and 834 are repeated for each of the plurality of determined duty cycles. Again, by generating frequency modulated I/O patterns for, for example, a 50% duty cycle, one embodiment of the present invention can further explore and validate the various switching frequency boundaries of the DUT in order to ensure electrical validation of the device.

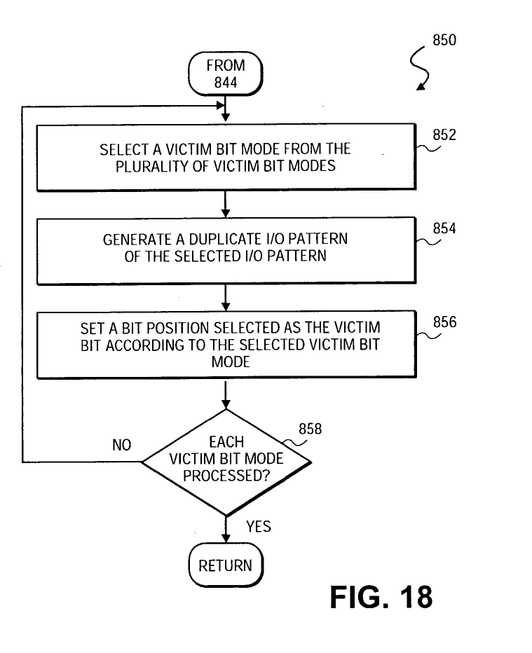

Referring now to FIG. 18, FIG. 18 depicts a flowchart illustrating an additional embodiment of a method 850 for generating additional I/O patterns of process block 844, as depicted in FIG. 15. At process block 852, a victim bit mode from the plurality of victim bit modes, for example, as provided in Table 1, is selected. Once selected, at process block 854, a duplicate I/O pattern of the selected I/O pattern of process block 840 is generated. Once generated, at process block 856, a bit position selected as the victim bit is set according to the selected victim bit mode.

In other words, additional I/O patterns are generated by assigning one bit within the I/O pattern as a victim bit and the remaining bits as aggressor bits. In one embodiment, the aggressor bits are set according to the designated (simulated) switching rate. Likewise, the victim bit is set according to victim mode, for example, as provided in Table 1. Finally, at process block 858, process blocks 852-856 are repeated for each of the plurality of victim bit modes provided in Table 1 to generate I/O patterns where aggressor lines switch according to a designated switching rate and victim bits are set according to a victim mode.

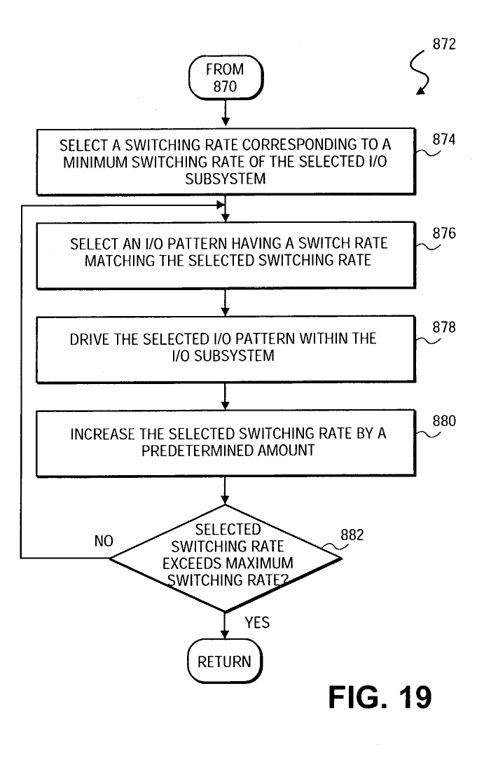

Referring now to FIG. 19, FIG. 19 depicts a flowchart illustrating an additional method 872 for driving I/O patterns within the selected I/O subsystem of process block 870, as depicted in FIG. 14, in accordance with one embodiment of the present invention. At process block 874, a switching rate corresponding to a minimum switching rate of the selected I/O subsystem is selected. Once selected, at process block 876, an I/O pattern having a switching rate matching the selected switching rate is selected. Once selected, at process block 878, the selected I/O pattern is driven within the I/O system. Next, at process block 880, the selected switching rate is increased by a predetermined amount. Finally, at process block 882, process blocks 876 and 880 are repeated until the selected switching rate exceeds the maximum switching rate.

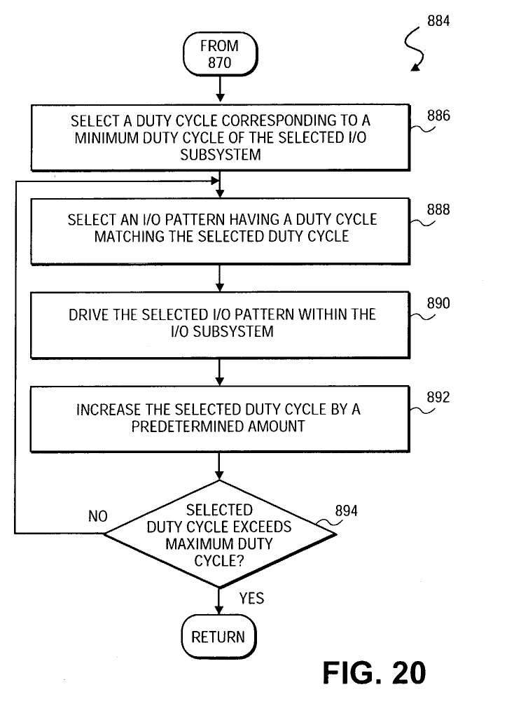

Accordingly, as depicted with reference to FIG. 19, I/O patterns are driven through the system by sweeping the switching rates of the various driven I/O patterns between the minimum and maximum switching rates of the selected I/O subsystem in order to cause the selected I/O subsystem to incur problematic system behavior. Likewise, I/O patterns may be driven through the system while cycling a duty cycle of the driven I/O patterns. Accordingly, as depicted with reference to FIG. 20, the duty cycles may be cycled through the driven I/O patterns in order to cause the I/O system to perform problematic behavior, such as, for example, system failure or the like, leading to corruption of the driven I/O patterns.

Finally, as depicted with reference to FIG. 20, FIG. 20 depicts a flowchart illustrating an additional method 884 for driving I/O patterns within the selected I/O subsystem of process block 870, as depicted with reference to FIG. 14 and in accordance with a further embodiment of the present invention. At process block 886, a duty cycle is selected, which corresponds to a minimum duty cycle of the selected I/O subsystem. Once selected, at process block 888, an I/O pattern having a duty cycle matching the selected duty cycle is selected. Next, at process block 890, the selected I/O pattern is driven within the I/O subsystem.

Once the I/O pattern is driven, at process block 892, the selected duty cycle is increased by a predetermined amount. Finally, at process block 894, process blocks 888-892 are repeated until the selected duty cycle exceeds a maximum duty cycle of the selected I/O subsystem. As such, I/O patterns are driven through the VO subsystem while sweeping the duty cycles of the various driven I/O patterns in order to cause the selected I/O subsystem to incur problematic behavior, such as, for example, a system failure to meet timing margins leading to corruption of the one or more driven I/O patterns.

Accordingly, utilizing the embodiments of the present invention, various devices within a platform chipset may be validated within a drastically reduced amount of time. In doing so, processor manufacturers can significantly reduce the time required to place a new device within the stream of commerce. Likewise, utilizing the electrical validation process embodiments described herein, processor manufacturers can detect worst case SSO conditions during the preliminary stages of electrical validation in order to correct the various SSO conditions in order to provide reliable product to consumers, which will provide good will to the processor manufacturers.

Alternate Embodiments

Several aspects of one implementation of the electrical validation system for providing electrical validation of a DUT have been described. However, various implementations of the electrical validation system provide numerous features including, complementing, supplementing, and/or replacing the features described above. Features can be implemented as part of the firmware or software or as part of the Vref card in different embodiment implementations. In addition, the foregoing description, for purposes of explanation, used specific nomenclature to provide a thorough understanding of the embodiments of the invention. However, it will be apparent to one skilled in the art that the specific details are not required in order to practice the embodiments of the invention.

In addition, although an embodiment described herein is directed to an electrical validation, it will be appreciated by those skilled in the art that the embodiments of the present invention can be applied to other systems. In fact, systems for component runtime simulation fall within the scope of the embodiments of the present invention, as defined by the appended claims. The embodiments described above were chosen and described in order to best explain the principles of the invention and its practical applications. These embodiments were chosen to thereby enable others skilled in the art to best utilize the invention and various embodiments with various modifications as are suited to the particular use contemplated.

It is to be understood that even though numerous characteristics and advantages of various embodiments of the present invention have been set forth in the foregoing description, together with details of the structure and function of various embodiments of the invention, this disclosure is illustrative only. In some cases, certain subassemblies are only described in detail with one such embodiment. Nevertheless, it is recognized and intended that such subassemblies may be used in other embodiments of the invention. Changes may be made in detail, especially matters of structure and management of parts within the principles of the embodiments of the present invention to the full extent indicated by the broad general meaning of the terms in which the appended claims are expressed.

The embodiments of the present invention provide many advantages over known techniques. In one embodiment, the present invention includes the ability to expedite rapid detection of worst case I/O margins within a limited amount of time. In one embodiment, the invention describes the generation of frequency domain SSO stress patterns in order to detect worst case voltage/timing I/O patterns, which result in system failures. Once one or more corrupted I/O patterns are detected, one embodiment of the invention provides a mode for isolating an uncorrupted version of the I/O patterns in order to detect the system failure.

By detecting the system failure during a beginning portion of the validation cycle, timely completion of electrical validation is ensured. Accordingly, platform failures and delays due to electrical platform issues are drastically reduce since worst case SSO patterns are detected during the beginning portions of the validation cycle. In addition, customers are allowed to test margins on their platform and provide feedback to microprocessor manufacturers.

Having disclosed exemplary embodiments and the best mode, modifications and variations may be made to the disclosed embodiments while remaining within the scope of the invention as defined by the following claims.

What is claimed is:

1. A method comprising:
driving a plurality of switching I/O patterns having a predetermined frequency content to achieve a plurality of varying stress levels within a selected I/O subsystem;
when a problematic I/O pattern is detected, driving, according to a user request, the problematic I/O pattern in isolation within the I/O subsystem to identify a source of problematic behavior within the I/O subsystem; and
once the problematic behavior is resolved, repeating, according to a user request, driving of the I/O patterns and driving of the problematic I/O pattern while margining a system timing and input reference voltage.

2. The method of claim 1, wherein driving the plurality of I/O patterns further comprises:
generating a plurality of I/O patterns having the predetermined frequency content;
selecting an I/O pattern from the plurality of generated I/O patterns;
driving the selected I/O pattern within the I/O subsystem; and
repeating the selecting and driving until a problematic I/O pattern is detected while driving of the selected I/O pattern through the I/O subsystem.

3. The method of claim 2, wherein generating further comprises:
selecting an I/O subsystem within a system for electrical validation;
determining a maximum switching rate of the selected I/O subsystem;
determining a minimum switching rate of the selected I/O subsystem; and
generating a plurality of I/O patterns to achieve switching rates within the minimum and maximum switching rates of the selected I/O subsystem.

4. The method of claim 3, wherein generating the plurality of I/O patterns further comprises:
selecting a duty cycle from one or more predetermined data cycles;
selecting an I/O pattern from the plurality of generated I/O patterns having the selected duty cycle;
altering the duty cycle of the selected I/O pattern to generate a plurality of I/O patterns to achieve the predetermined switching rate content according to the minimum and maximum switching rates; and
repeating the selecting, selecting and altering for each of the predetermined duty cycles.

5. The method of claim 1, wherein prior to driving the problematic I/O pattern, the method further comprises:
determining one or more I/O patterns corrupted during driving of the plurality of I/O patterns through the I/O subsystem as the problematic I/O pattern; and
once the one or more corrupted I/O patterns are determined, generating a failing data screen to notify the user of possible problematic system behavior.

6. The method of claim 5, further comprising:
determining a data failure address of each of the one or more corrupted I/O patterns;
determining an input reference voltage level;
determining an uncorrupted version of each of the one or more corrupted I/O patterns; and
generating an error log file containing each data failure address, each pattern switching rate, the reference voltage level, each corrupted I/O pattern, and an uncorrupted version of each of the one or more corrupted I/O patterns.

7. The method of claim 5, wherein generating the failing data screen further comprises:
displaying a data failure address of each of the one or more corrupted I/O patterns;
displaying an input reference voltage level during corruption of the one or more I/O patterns;
displaying each of the one or more corrupted I/O patterns; and
displaying an uncorrupted version of each of the one or more corrupted I/O patterns.

8. The method of claim 1, wherein driving the problematic I/O pattern further comprises:
receiving a corrupted I/O pattern as the detected problematic I/O pattern;
determining a non-corrupted version of the corrupted I/O pattern;
driving the non-corrupted version of the I/O pattern within the I/O subsystem; and
repeating the driving of the non-corrupted I/O pattern until a source of the corrupted I/O pattern is detected.

9. The method of claim 8, wherein driving further comprises:
generating a debug mode screen to illustrate driving of the I/O pattern within the subsystem to identify a source of the problematic system behavior.

10. The method of claim 1, wherein repeating further comprises:
selecting an input reference voltage within a predetermined reference voltage range of the I/O subsystem selected for electrical validation;
providing the selected input reference voltage to the selected I/O subsystem; and
repeating the driving, driving, repeating, selecting and providing for each input reference voltage level within the reference voltage range of the selected I/O subsystem.

11. A computer readable storage medium including program instructions that direct a computer to perform one or more operations when executed by a processor, the one or more operations comprising:
driving a plurality of switching I/O patterns having a predetermined frequency content to achieve a plurality of varying stress levels within a selected I/O subsystem;
when a problematic I/O pattern is detected, driving, according to a user request, the problematic I/O pattern in isolation within the I/O subsystem to identify a source of problematic behavior within the I/O subsystem; and
once the problematic behavior is resolved, repeating, according to a user request, driving of the I/O patterns and driving of the problematic I/O pattern while margining a system timing and input reference voltage.

12. The computer readable storage medium of claim 11, wherein driving the plurality of I/O patterns further comprises:
generating a plurality of I/O patterns having the predetermined frequency content;
selecting an I/O pattern from the plurality of generated I/O patterns;
driving the selected I/O pattern within the I/O subsystem; and
repeating the selecting and driving until a problematic I/O pattern is detected while driving of the selected I/O pattern through the I/O subsystem.

13. The computer readable storage medium of claim 12, wherein generating further comprises:
selecting an I/O subsystem within a system for electrical validation;
determining a maximum switching rate of the selected I/O subsystem;
determining a minimum switching rate of the selected I/O subsystem; and
generating a plurality of I/O patterns to achieve switching rates within the minimum and maximum switching rates of the selected I/O subsystem.

14. The computer readable storage medium of claim 13, wherein generating the plurality of I/O patterns further comprises:
selecting a duty cycle from one or more predetermined data cycles;
selecting an I/O pattern from the plurality of generated I/O patterns having the selected duty cycle;
altering the duty cycle of the selected I/O pattern to generate a plurality of I/O patterns to achieve the predetermined switching rate content according to the minimum and maximum switching rates; and
repeating the selecting, selecting and altering for each of the predetermined duty cycles.

15. The computer readable storage medium of claim 11, wherein prior to driving the problematic I/O pattern, the method further comprises:
determining one or more I/O patterns corrupted during driving of the plurality of I/O patterns through the I/O subsystem as the problematic I/O pattern; and
once the one or more corrupted I/O patterns are determined, generating a failing data screen to notify the user of possible problematic system behavior.

16. The computer readable storage medium of claim 15, further comprising:
determining a data failure address of each of the one or more corrupted I/O patterns;
determining an input reference voltage level;
determining an uncorrupted version of each of the one or more corrupted I/O patterns; and
generating an error log file containing each data failure address, each pattern switching rate, the reference voltage level, each corrupted I/O pattern, and an uncorrupted version of each of the one or more corrupted I/O patterns.

17. The computer readable storage medium of claim 15, wherein generating the failing data screen further comprises:
displaying a data failure address of each of the one or more corrupted I/O patterns;
displaying an input reference voltage level during corruption of the one or more I/O patterns;
displaying each of the one or more corrupted I/O patterns; and
displaying an uncorrupted version of each of the one or more corrupted I/O patterns.

18. The computer readable storage medium of claim 11, wherein driving the non-corrupted version of the corrupted I/O pattern further comprises:
receiving a corrupted I/O pattern as the detected problematic I/O pattern;
determining a non-corrupted version of the corrupted I/O pattern;
driving the non-corrupted version of the I/O pattern within the I/O subsystem; and
repeating the driving of the non-corrupted I/O pattern until a source of the corrupted I/O pattern is detected.

19. The computer readable storage medium of claim 18, wherein driving further comprises:
generating a debug mode screen to illustrate driving of the I/O pattern within the system to identify a source of the system failure.

20. The computer readable storage medium of claim 11, wherein repeating further comprises:
selecting a reference voltage within a predetermined reference voltage range of a device selected for electrical validation;
providing the selected reference voltage to the selected device; and
repeating the driving, driving, repeating, selecting and providing for each input reference voltage level within the reference voltage range of the selected device.

21. A system, comprising:
a processor having circuitry to execute instructions;
a margin card coupled to the processor via a parallel port, the margin card to provide an input reference voltage, within a predetermined reference voltage range, to an I/O subsystem selected for electrical validation; and
a storage device coupled to the processor, having sequences of instructions stored therein, which when executed by the processor cause the processor to:
drive a plurality of switching I/O patterns having a predetermined frequency content to achieve a plurality of varying system stress levels within the selected I/O subsystem,
when a problematic I/O pattern is detected, drive, according to a user request, the problematic I/O pattern in isolation within the I/O subsystem to identify a source of problematic behavior within the I/O subsystem, and
once the problematic behavior is resolved, repeat, according to a user request, driving of the I/O patterns and driving of the problematic I/O patterns while margining a system timing and input reference voltage.

22. The system of claim 21, wherein the margin card comprises:
one or more potentiometers coupled to a parallel output port to generate reference voltage Vref signals; and
one or more reference voltage Vref output signal lines coupled between the potentiometers and the selected system device to provide Vref signals thereto.

23. The system of claim 21, wherein the margin card further comprises:
a printed circuit board PCB;
the one or more potentiometers fabricated onto the PCB; and
a parallel output port formed onto the PCB.

24. The system of claim 21, wherein the margin card comprises:
a quad potentiometer fabricated onto a PCB to generate reference voltage Vref signals; and
a parallel output port fabricated onto the PCB to provide a device interference to the selected device and provide the Vref signals to the device.

25. The system of claim 24, wherein the processor is caused to:
generate a debug mode screen to illustrate driving of the I/O pattern within the I/O subsystem to identify a source of problematic behavior within the I/O subsystem.

26. The system of claim 21, wherein the selected I/O subsystem comprises:
one of a front side bus, an AGP port, a memory control hub and an I/O controller hub.

27. A method comprising:
generating a plurality of switching I/O patterns having a predetermined frequency content;
driving the plurality of I/O patterns to achieve a plurality of varying stress levels within an I/O subsystem selected for electrical validation; and
when a problematic I/O pattern is detected, notifying a user of possible problematic behavior within the I/O subsystem.

28. The method of claim 27, wherein generating the plurality of I/O patterns further comprises:
generating a plurality of I/O patterns to achieve switching rates within a minimum and maximum switching rate of the I/O subsystem;
selecting an I/O pattern from the plurality of generated I/O patterns;
selecting a bit within the selected I/O pattern as a victim bit;
generating a plurality of additional I/O patterns by varying a value of the selected bit according to a plurality of predetermined victim bit modes;
repeating selecting the bit and generating for each bit within the selected I/O pattern; and
repeating the selecting, selecting, generating and repeating for each of the generated I/O patterns.

29. The method of claim 28, wherein generating the plurality of I/O patterns further comprises:
selecting a duty cycle from a plurality of predetermined duty cycles according to the maximum switching rate and minimum switching rate of the selected I/O subsystem;
selecting an I/O pattern having the selected duty cycle;
altering the duty cycle of the selected I/O pattern to generate a plurality of I/O patterns having the predetermined switching rate content; and
repeating the selecting and generating for each predetermined duty cycle.

30. The method of claim 29, further comprising:
selecting a duty cycle from the one or more predetermined duty cycles;
combining I/O patterns having the selected duty cycle to form a plurality of frequency modulated I/O patterns; and
repeating the selecting and combining for each of the one or more predetermined duty cycles.

31. The method of claim 28, wherein generating additional I/O patterns further comprises:
selecting a victim bit mode from the plurality of victim bit modes;
generating a duplicate I/O pattern of the selected I/O pattern;
setting a bit position selected as the victim bit according to the selected victim bit mode; and
repeating the selecting, generating and setting for each of the plurality of victim bit modes.

32. The method of claim 27, wherein driving the I/O patterns further comprises:
selecting a switching rate corresponding to a minimum switching rate of the selected I/O subsystem;
selecting an I/O pattern having a switching rate matching the selected switching rate;
driving the selected I/O pattern within the I/O subsystem;
increasing the selected switching rate by a predetermined amount; and
repeating the selecting the I/O pattern, driving the I/O pattern and increasing the selected switching rate period until the selected switching rate exceeds a maximum switching rate of the selected I/O subsystem.

33. The method of claim 27, wherein driving the I/O patterns further comprises:
selecting a duty cycle corresponding to a minimum duty cycle of the selected I/O subsystem;
selecting an I/O pattern having a duty cycle matching the selected duty cycle;
driving the selected I/O pattern within the I/O subsystem;
increasing the selected duty cycle by a predetermined amount; and
repeating the selecting the I/O pattern, driving the I/O pattern and increasing the selected duty cycle period until the selected duty cycle exceeds a maximum predetermined duty cycle of the selected I/O subsystem.

34. A computer readable storage medium including program instructions that direct a computer to perform one or more operations when executed by a processor, the one or more operations comprising:
generating a plurality of switching I/O patterns having a predetermined frequency content;
driving the plurality of I/O patterns to achieve a plurality of varying stress levels within an I/O subsystem selected for electrical validation; and
when a problematic I/O pattern is detected, notifying a user of possible problematic behavior within the I/O subsystem.

35. The computer readable storage medium of claim 34, wherein generating the plurality of I/O patterns further comprises:
generating a plurality of I/O patterns to achieve switching rates within a minimum and maximum switching rate of the I/O subsystem;
selecting an I/O pattern from the plurality of generated I/O patterns;
selecting a bit within the selected I/O pattern as a victim bit;
generating a plurality of additional I/O patterns by varying a value of the selected bit according to a plurality of predetermined victim bit modes;
repeating selecting the bit and generating for each bit within the selected I/O pattern; and
repeating the selecting, selecting, generating and repeating for each of the generated I/O patterns.

36. The computer readable storage medium of claim 35, wherein generating the plurality of I/O patterns further comprises:
selecting a duty cycle from a plurality of predetermined duty cycles according to the maximum switching rate and minimum switching rate of the selected I/O subsystem;
selecting an I/O pattern having the selected duty cycle;
altering the duty cycle of the selected I/O pattern to generate a plurality of I/O patterns having the predetermined switching rate content; and
repeating the selecting and generating for each predetermined duty cycle.

37. The computer readable storage medium of claim 36, further comprising:
selecting a duty cycle from the one or more predetermined duty cycles;
combining I/O patterns having the selected duty cycle to form a plurality of frequency modulated I/O patterns; and
repeating the selecting and combining for each of the one or more predetermined duty cycles.

38. The computer readable storage medium of claim 33, wherein generating additional I/O patterns further comprises:
selecting a victim bit mode from the plurality of victim bit modes;
generating a duplicate I/O pattern of the selected I/O pattern;
setting a bit position selected as the victim bit according to the selected victim bit mode; and
repeating the selecting, generating and setting for each of the plurality of victim bit modes.

39. The computer readable storage medium of claim 34, wherein driving the I/O patterns further comprises:
selecting a switching rate corresponding to a minimum switching rate of the selected I/O subsystem;
selecting an I/O pattern having a switching rate matching the selected switching rate;
driving the selected I/O pattern within the I/O subsystem;
increasing the selected switching rate by a predetermined amount; and
repeating the selecting the I/O pattern, driving the I/O pattern and increasing the selected switching rate period until the selected switching rate exceeds a maximum switching rate of the selected I/O subsystem.

40. The computer readable storage medium of claim 34, wherein driving the I/O patterns further comprises:
selecting a duty cycle corresponding to a minimum duty cycle of the selected I/O subsystem;
selecting an I/O pattern having a duty cycle matching the selected duty cycle;
driving the selected I/O pattern within the I/O subsystem;
increasing the selected duty cycle by a predetermined amount; and
repeating the selecting the I/O pattern, driving the I/O pattern and increasing the selected duty cycle period until the selected duty cycle exceeds a maximum predetermined duty cycle of the selected I/O subsystem.
